(19) United States
(12) Patent Application Publication
(10) Pub. No.: US 2002/0069089 A1
(43) Pub. Date: Jun. 6, 2002

(54) Method for case management of workplace-related injuries

(75) Inventors: John J. Larkin, Cincinnati, OH (US); Michael Holbert, Maineville, OH (US); Donald L. Seddon, Medina, OH (US); Carl V. Santoiemmo, Willoughby Hills, OH (US); Thomas L. Seddon, Medina, OH (US)

Correspondence Address: Patrick R. Roche, Fay, Sharpe, Fagan,, Minnich & McKee, LLP, 1100 Superior Avenue, 7th Floor, Cleveland, OH, 44114-2518, US

(73) Assignee: NUPATH SOLUTIONS (Cincinnati), LTD.

(21) Appl. No.: 09/899,425

(22) Filed: Jul. 5, 2001

Related U.S. Application Data
(60) Provisional application No. 60/250,161, filed on Nov. 30, 2000.

(51) Int. Cl. G06F 17/60

(52) U.S. Cl. 705/4

(57) ABSTRACT

A case management system has a central data store (4) comprising at least one data storage unit. An injury classification code database (4A), treatment database (4B), and diagnosis database (4C) are maintained thereon. A processor (8) in operative communication with the data store (4) and the Internet (2) performs the steps of: creating (14) a claim file on the data store (4); receiving information (12, 22, 36, 86, 88, 102, 304) about the claim via the Internet (2); storing (16, 52, 308) the received information in the claim file; establishing a diagnosis (32, 34, 36); creating a treatment plan (50) based on the diagnosis using the treatment database (4B); and transmitting (82, 84, 90, 301, 302) information from the claim file via the Internet (2) upon receipt of valid security information. Establishing a diagnosis (32, 34, 36) optionally includes receiving responses (22) to an Internet questionnaire and determining a suggested diagnosis by comparing with the diagnosis database (32). The treatment plan is preferably divided into intervals (60) corresponding to pre-selected time intervals.

This application claims the benefit of U.S. Provisional Application No. 60/250,161, filed on Nov. 30, 2000.

### BACKGROUND OF THE INVENTION

The present invention relates to health care management. It has particular application in the area of workplace-related injury management, and will be described with particular reference thereto. However, the invention will also find application in conjunction with other types of medical case management.

A case management provider (CMP) is an entity which specializes in classifying, tracking, and managing medical cases within an assigned pool of medically insured individuals. Typical CMP organizations include managed care organizations (MCO's), insurance companies, and the like. CMP's are frequently contracted by businesses and other employers to efficiently administer medical care to covered employees.

An important aspect of CMP performance relates to the management of work-related injuries. Such cases usually fall within the regulatory scope of state workers' compensation agencies. In Ohio, for example, the Bureau of Workers' Compensation (BWC) regulates the thirty-seven MCO's presently operating within the state with respect to workplace-related injuries. The BWC assesses MCO performance largely based on data provided by the MCO's.

In the past, the BWC measured MCO performance using a formula based upon claims reporting promptness and accuracy. Recently, however, there has been a move in Ohio as well as in other states toward an outcome-based metric, wherein MCO performance ratings are based on the speed and effectiveness of injured worker rehabilitation. Specifically, the BWC is adopting the Degree of Disability Management (DoDM) tool to measure MCO effectiveness in managing treatment and returning workers to employment in either a full-time or a reduced capacity. The DoDM metric is based upon the recognition that the most significant cost in a worker's compensation claim is usually the time lost from work, defined as the disability, as opposed to the medical and related resources involved in treatment and rehabilitation. Hence, the DoDM program focuses on disability management rather than resource management. The DoDM assesses injuries based upon the ICD-9 (International Classification of Diseases, 9th) injury classification code, and calculates measurable disability management goals such as an expected return-to-work date based upon the ICD-9 code and an NCCI (National Council on Compensation Insurance) employee job classification.

In this new regulatory environment, there is an urgent need for a comprehensive and uniform care plan method by which MCO's may classify, track, manage, and report the provided care of workplace-related injuries throughout the rehabilitation process, from the first report of injury (FROI), through recovery and return to work. The prior art includes methods for claims management, whereby the FROI and related data are collected for each claim. However, these prior methods do not include mechanisms for case management, whereby the method proactively manages a case.

### SUMMARY OF THE INVENTION

According to one aspect of the invention, a case management method for managing a worker injury claim includes a database of suggested treatment plans. A first report of injury (FROI) date is recorded. An injured body part is identified. An injury diagnosis is obtained. An injury classification code is assigned based on the obtained diagnosis and the identified injured body part. An associated job code is received. A degree of disability management (DoDM) code is identified based on the injury classification code and the associated job code. A treatment plan is provided based on the diagnosis, said treatment plan being extracted from the database of treatment plans.

Preferably, the step of assigning an injury classification code includes assigning an ICD-9 code.

Preferably, the step of receiving an associated job code includes receiving an associated NCCI job code.

Preferably, the step of identifying a DoDM code includes identifying a loosely managed benchmark code, and identifying a well managed benchmark code. The step of identifying a loosely managed benchmark code can include identifying a statistical average period between injury and return to work corresponding to the injury classification code and the associated job code. The step of identifying a well managed benchmark code can include estimating a period between injury and return to work corresponding to the injury classification code and the associated job code based on the provided treatment plan. The method optionally also includes the step of estimating an estimated return-to-work date based upon the first report of injury (FROI) date and the well managed benchmark. This is optionally done by calculating an estimated return to work date by adding the well-managed benchmark to the FROI date.

Preferably, the step of obtaining a diagnosis includes the steps of receiving responses to a diagnostic questionnaire, and supplying a suggested diagnosis by comparing the responses with a preexisting diagnosis database.

The method preferably further includes dividing the treatment plan into treatment intervals wherein each said interval is assigned to a time block subsequent to the first report of injury (FROI). In this case, the method optionally further includes receiving updated information on the injured worker, said updated information having become available after the first report of injury (FROI) and after the obtaining of the injury diagnosis, updating a treatment interval based upon the updated information, and updating the estimated return-to-work date based upon the updated information. The step of receiving updated information preferably includes receiving information from a diagnostic testing of the injured worker. The method can further include scheduling the diagnostic testing of the injured worker in accordance with the treatment interval. The scheduling can additionally include pre-certifying the diagnostic testing conditional upon the diagnostic testing being included in the treatment plan.

The method optionally further includes displaying initial case management tracking information, receiving from the user additional case management tracking information, and appending the received additional case management tracking information to the initial case management tracking information without modifying the initial case management tracking information. The displaying case management tracking information optionally includes displaying URAC-compliance case management tracking information. In this case, the method preferably further includes setting a URAC compliance flag conditional upon meeting a preselected set of conditions indicating compliance with URAC standards.

According to another aspect of the invention, a case management system for managing rehabilitation of an injured worker includes a central data store comprising at least one data storage unit. An injury classification code database is maintained on the central data store. A treatment database is maintained on the central data store. A processor is in operative communication with the central data store and in operative communication with the Internet. The processor performs the steps of: creating a claim file on the central data store; receiving information about the claim via the Internet; storing the received information in the claim file; establishing a diagnosis; creating a treatment plan based on the diagnosis using information extracted from the treatment database; and selectably transmitting selected information extracted from the claim file via the Internet conditional upon receipt of valid security information.

Preferably, the system further includes a diagnosis database that is maintained on the central data store, and an Internet diagnosis questionnaire that is accessible via the Internet. In this case, the step of establishing a diagnosis preferably includes the steps of receiving responses to the Internet-based diagnosis questionnaire via the Internet, and providing a suggested diagnosis by comparing the received responses with information contained in the diagnosis database.

The step of creating a treatment plan preferably includes the step of dividing the treatment plan into treatment intervals corresponding to pre-selected time intervals.

The processor optionally performs the additional steps of providing a pre-certification for a diagnostic test in accordance with the created treatment plan, receiving results of the diagnostic test, and updating the treatment plan based on the received results and the treatment database.

The processor optionally performs the additional steps of identifying a loosely managed benchmark code and identifying a well managed benchmark code. The identifying of a loosely managed benchmark code preferably includes identifying a statistical average period between injury and return to work corresponding to the injury classification code and the associated job code. The step of identifying a well managed benchmark code preferably includes estimating a period between injury and return to work corresponding to the injury classification code and the associated job code based on the provided treatment plan. Preferably, an estimated return-to-work date is estimated based upon the first report of injury (FROI) date and the well managed benchmark. The step of estimating an estimated return-to-work date preferably includes calculating an estimated return to work date by adding the well-managed benchmark to the FROI date.

One advantage of the present invention is that it provides a protocol for assigning an appropriate injury classification, e.g. an ICD-9 injury classification code, for each case based on an assessment of the symptoms.

Another advantage of the present invention is that it provides a recommended program of treatment which is updated on a bi-weekly basis.

Another advantage of the present invention is that it provides a patient prognosis and estimated patient rehabilitation timetables which are related to a range of job-related tasks, again updated on a bi-weekly basis.

Yet another advantage of the present invention is that it is compatible with the DoDM tool which is being adopted by Ohio and many other states for assessing workplace-related injury case management, thereby facilitating CMP compliance with governmental reporting requirements.

Still yet another advantage of the present invention is that it may be embodied in the form of an Internet-based tool whereby medical tests and treatment are pre-certified based upon the treatment diagnosis. This greatly reduces paperwork and paperwork-related delays.

Still further advantages and benefits of the present invention will become apparent to those of ordinary skill in the art upon reading the following detailed description of the preferred embodiment.

### BRIEF DESCRIPTION OF THE DRAWINGS

The invention may take form in various components and arrangements of components, and in various steps and arrangements of steps. The drawings are only for the purpose of illustrating preferred embodiments and are not to be construed as limiting the invention.

FIG. 1 is a diagrammatic representation of a preferred Internet-based embodiment of the invention;

FIG. 2 is a block diagram of the initiation of a new claim in accordance with one embodiment of the invention;

FIG. 3 is a block diagram of the portion of the embodiment wherein the diagnosis and treatment are established;

FIG. 4 is a block diagram of the treatment plan, particularly showing the scheduling and receipt of testing data by the method, in accordance with one embodiment of the invention;

FIG. 5 is a block diagram of the portion of the embodiment wherein the degree of disability management (DoDM) code is determined;

FIG. 6 is a block diagram of the process for qualifying an actual return to work date;

FIG. 7 shows a typical screen shot displaying the diagnostic, pain management and return to work portions of an exemplary treatment plan interval according to the embodiment of the invention;

FIG. 8 shows a typical screen shot displaying the physical therapy guidelines portions of an exemplary treatment plan interval according to the embodiment of the invention;

FIG. 9 shows an exemplary C-9 physicians report/treatment plan report in accordance with one embodiment of the invention; and

FIG. 10 shows a preferred embodiment of the interfacing aspect of the invention with regulatory record-keeping in accordance with the URAC standards.

### detailed DESCRIPTION OF THE PREFERRED EMBODIMENTS

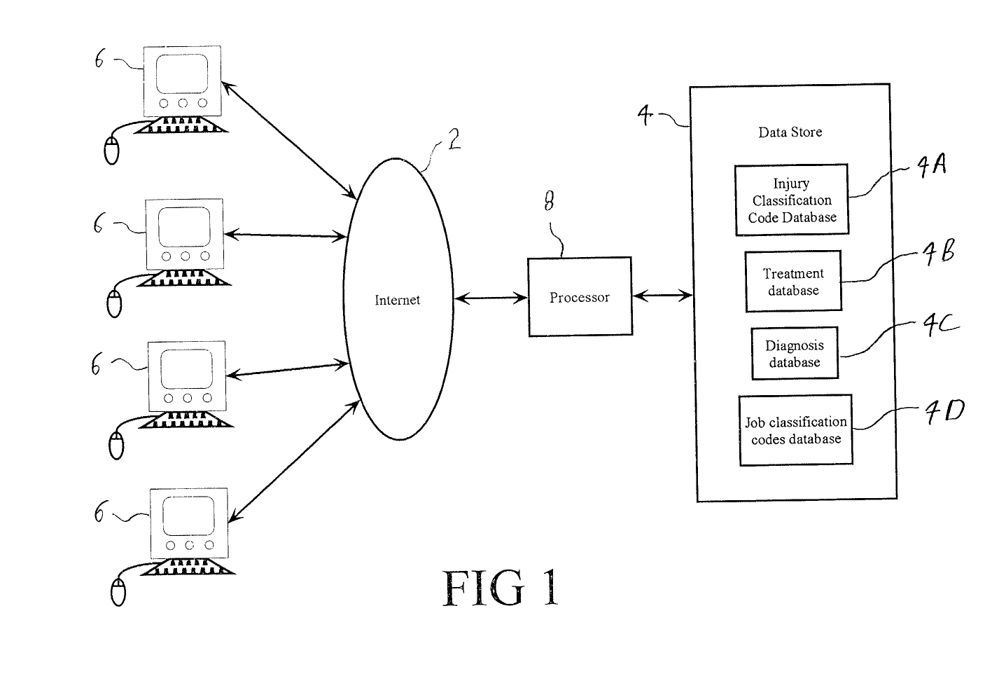

A preferred embodiment of the managed care system will be described with initial reference to FIG. 1. The preferred embodiment is advantageously implemented via the Internet 2, and will be described with reference thereto. However, it is to be appreciated that the method is not limited to an Internet platform, but rather is also implementable on an electronic network, a computer network, or the like. The invention is typically tangibly embodied in a computer-readable device or media, such as memory, data storage devices, and/or data communications devices, thereby making a computer program product or article of manufacture according to the invention.

In the preferred Internet-based embodiment, information related to the injured worker, e.g. the ongoing treatment plan, records required for URAC compliance, such as the first report of injury (FROI) date, and et cetera are preferably stored on a central data store 4 that is accessible by client MCO's and other subscribers 6 via the Internet 2. The central data store 4 is typically a computer-readable device or media such as a disk storage unit. In addition to maintaining claim records on the injured worker, the data store 4 preferably stores databases that are used in implementing the managed care system. These databases can include an injury classification database 4A, a treatment database 4B, a diagnosis database 4C, a job classification codes database 4D, and the like. Of course, it will be appreciated that separate data stores or other storage arrangements can be used for recording and storing the claim records and the databases 4A, 4B, 4C, 4D.

Because MCO's typically operate within a regulated environment, some of these databases preferably contain standardized information. For example, the injury classification code database 4A preferably contains standard ICD-9 codes consistent with the 9th International Classification of Diseases. The job classification codes database preferably contains job codes developed by the National Council on Compensation Insurance (NCCI job codes). Other databases, such as the treatment database 4B and the diagnosis database 4C, typically contain information developed by medical research teams, e.g. in the form of summaries or distillations of actual medical case studies.

Preferably, each subscriber 6 is limited to accessing only claims that are initiated by that provider and are maintained for that provider on the data store 4 by the managed care system. Information security measures sufficient to ensure such controlled access are well-known to those of ordinary skill in the art and need not be described herein for an enabling disclosure of the invention. Typically, such security measures include at least requiring the user to supply valid authentication information such as a username and associated password before being allowed access to the data store 4.

The system also preferably includes a processor 8 in operative communication with the data store 4 and the Internet 2. The processor performs the steps required to implement the managed care system as described next, as well as typically providing the communication interface with the Internet. The processor 8 is preferably embodied as a mainframe computer system, a server system, or the like.

It will be appreciated by those of ordinary skill in the art that the system architecture just described with reference to FIG. 1 is exemplary only, and that many changes and variants thereof are possible. It is intended that all such changes and variants fall within the scope of the invention insofar as they fall within the scope of the appended claims.

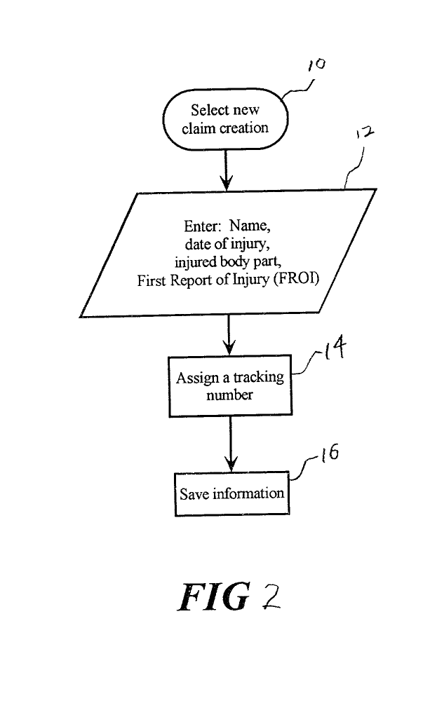

With continuing reference to FIG. 1 and with further reference to FIG. 2, the creation of a new claim is described. A user selects the new claim creation option on an associated computer terminal 6 in a step 10. Typically, only a limited amount of initial information will be entered to create the claim, and additional interfacing dialog windows are provided subsequent to the claim creation whereby the user accesses, updates, and maintains the claim. In a step 12, the initial information entered includes the name of the injured person, the date of injury, the injured body part, and the first report of injury (FROI). Of course other or different information, such as a social security number, is optionally requested or required during claim creation. Preferably, the FROI is recorded as the current computer system date. In this way, the user need not enter a FROI date, and any required reporting paperwork, e.g. to a regulatory agency, is optionally automatically generated thereby avoiding possible clerical errors. Upon entering the initial information, the claim is assigned a tracking number in a step 14, and the information is saved in a step 16, preferably to the data store 4.

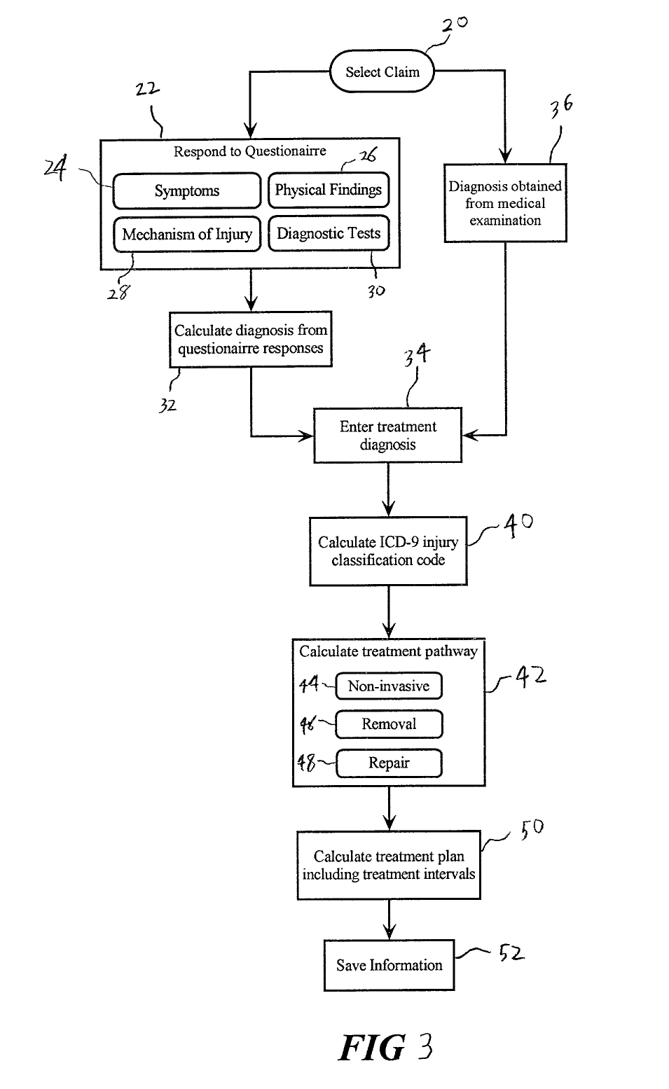

With reference now to FIG. 3, a preferred method for determining an injury diagnosis and a treatment plan is described. It will be appreciated that typically this will be the next step performed by the user, since the injury usually is diagnosed prior to other useful case management operations. However, the recited order of processing elements is not intended to limit the claimed process to any particular order, except insofar as the claims specifically call for a particular order.

The claim is selected from the data store 4 in a step 20. claim selection is preferably done by the user 6 in any convenient manner, such as by searching the last name, the social security number, the tracking number, or the like. Once a claim has been selected, the injury diagnosis is specified. In a preferred embodiment, there are two paths through which injury diagnosis information can be supplied.

In a first path, information is supplied by responding to a questionnaire in a step 22. In the Internet embodiment, this questionnaire is preferably an electronic questionnaire in the form of one or more Internet web pages which are electronically filled out by the user 6. In a preferred embodiment, the questionnaire includes sections on the symptoms 24, physical findings 26, mechanism of injury 28, and diagnostic tests 30, as these data are typically useful in making a medical diagnosis. Once the medical information is supplied through the questionnaire in the step 22, a suggested diagnosis is preferably determined in a step 32.

The suggested diagnosis of the step 32 is preferably determined based on comparing the questionnaire responses with the contents of the diagnosis database 4C. The diagnosis database 4C typically contains a plurality of diagnoses along with the symptoms typically associated therewith. For many workplace-related applications, the diagnoses in the diagnosis database 4C preferably include mechanical injuries, e.g. broken bones, sprained or damaged muscles, back injuries, and the like. However, the diagnosis database 4C can of course include other or different diagnosis areas. For example, the diagnosis database 4C advantageously includes chemical injuries (e.g. burns, poisoning, et cetera) where the case management system is used in conjunction with subscribers 6 who manufacture or use toxic or corrosive substances. The suggested diagnosis generated in the step 32 is preferably supplied as a default recommended value for the treatment diagnosis input 34.

In a second path, diagnosis information is supplied by a medical professional, e.g. by a licensed doctor, in a step 36. The doctor can advantageously have the filled-out questionnaire available during examination of the injured worker as an aid in making the diagnosis. The doctor's diagnosis is then entered as the treatment diagnosis in step 34. Preferably, any conflict between the recommended treatment diagnosis generated in the step 32 and the treatment diagnosis 36 supplied by a doctor is resolved in favor of the doctor's diagnosis 36.

Once a diagnosis is entered in the step 34, the method extracts an injury classification code corresponding to the diagnosis from the injury classification database 4A in a step 40. The injury classification code is preferably compliant with the relevant regulatory agency classification scheme, e.g. a standard ICD-9 injury classification code. Based on the treatment diagnosis a treatment pathway is preferably determined in a step 42. In the illustrated embodiment three pathways are selectable: a non-invasive pathway 44, a removal pathway 46, and a repair pathway 48. The treatment pathway is typically associated with the diagnosis and can be stored in the diagnosis database 4C. Optionally, the selected treatment pathway can be manually overridden, e.g. a different treatment pathway can be selected, e.g. on the advice of the treating physician.

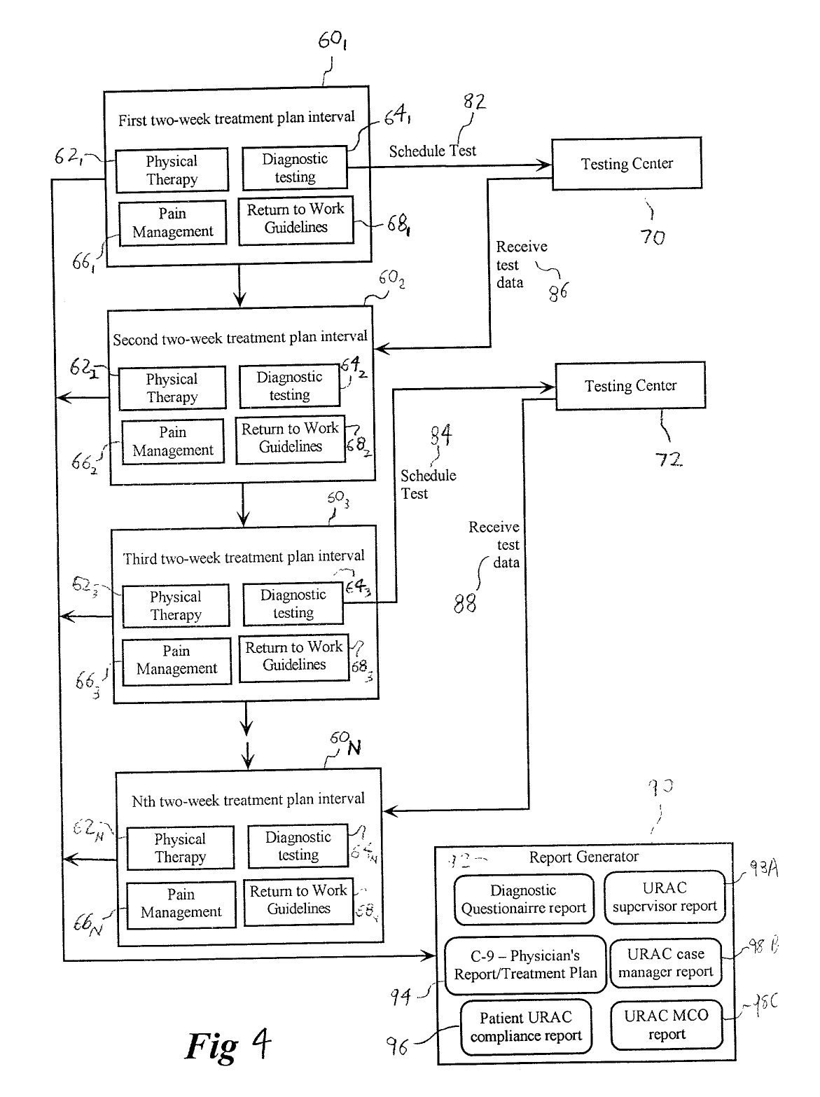

With the diagnosis and treatment pathway established, a treatment plan is then calculated in a step 50. The treatment plan is preferably extracted from the treatment database 4B based on the treatment diagnosis, optionally taking into account other factors such as the injured worker's age. Preferably, the treatment plan is divided into fixed time intervals (discussed with reference to FIG. 4 next) to facilitate tracking of the rehabilitation progress over time. Finally, the information is saved in a step 52.

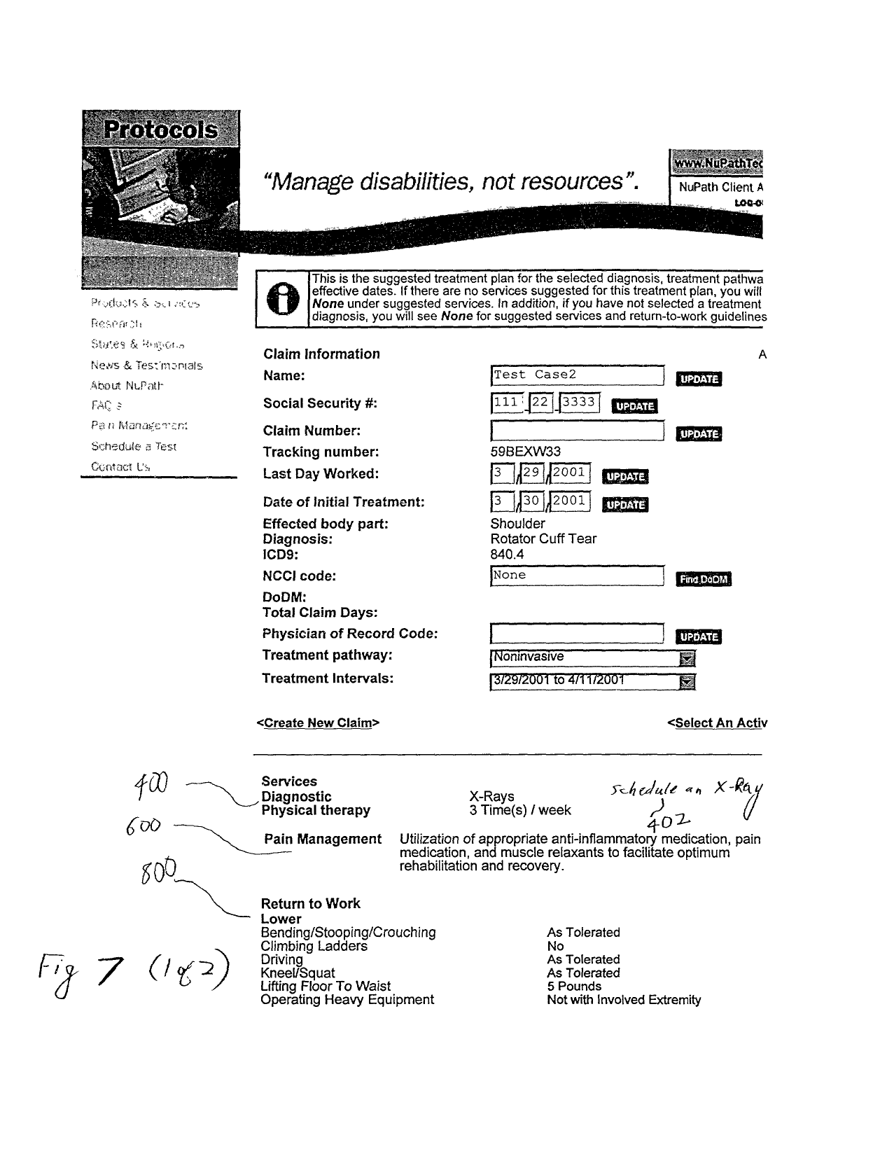

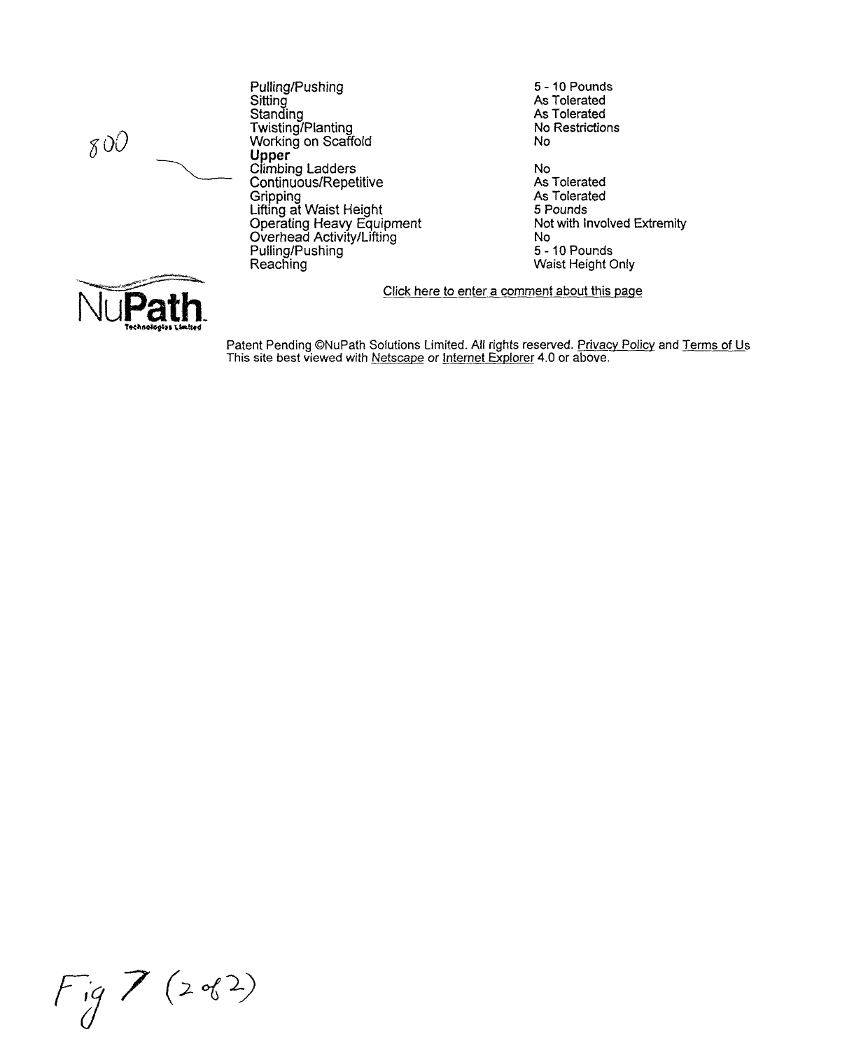

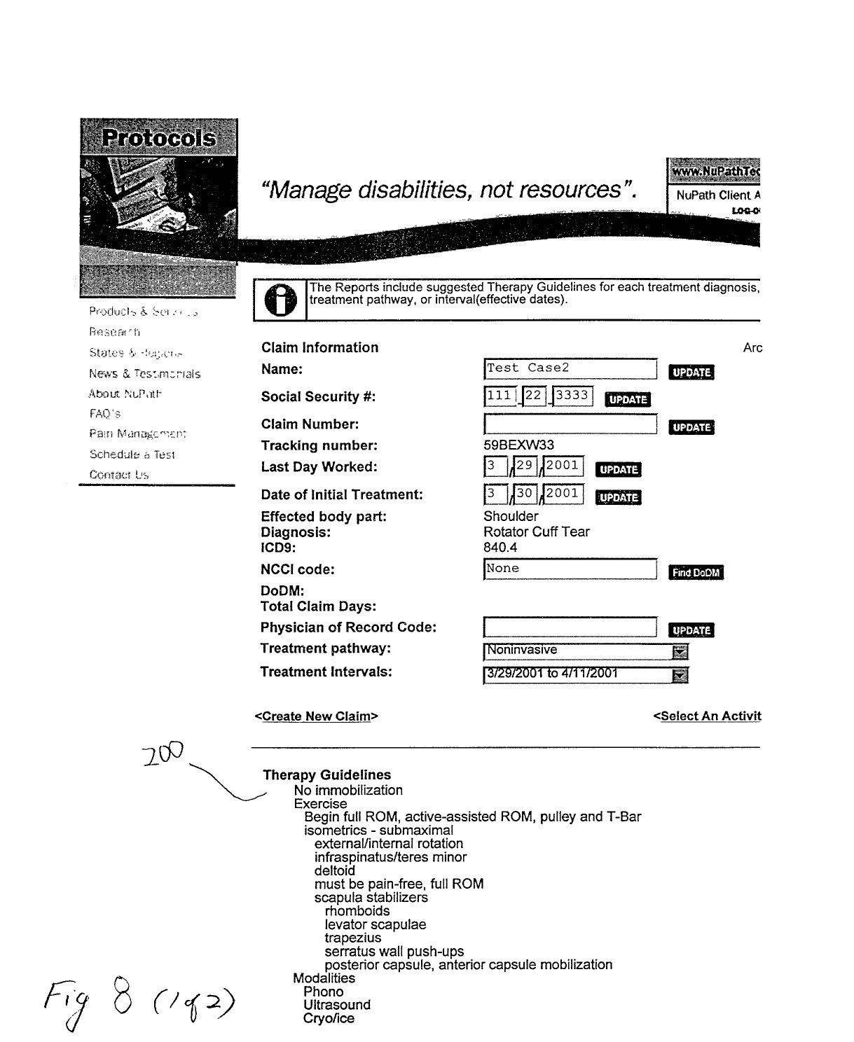

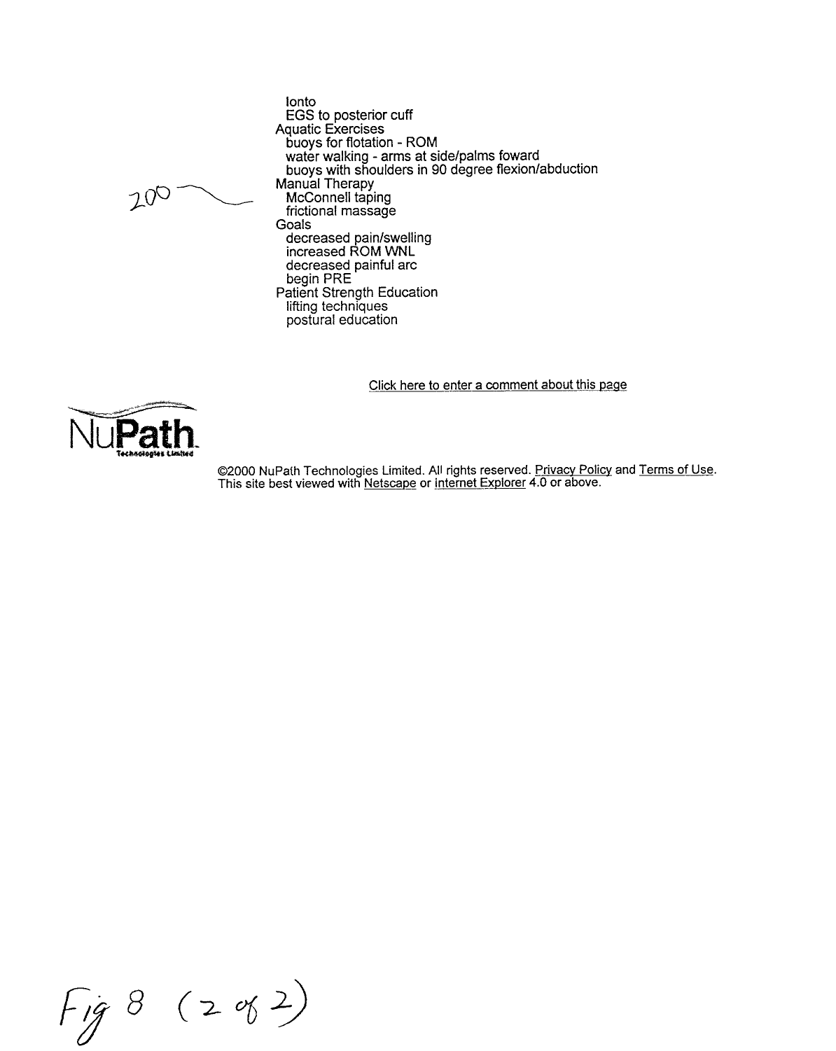

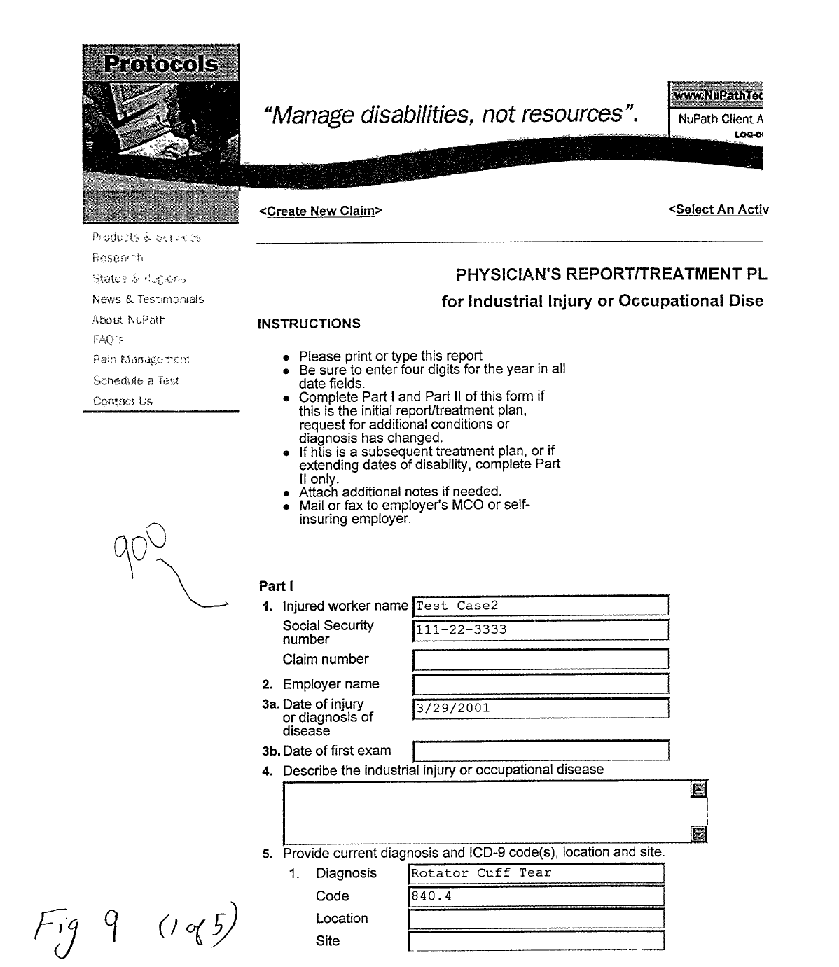

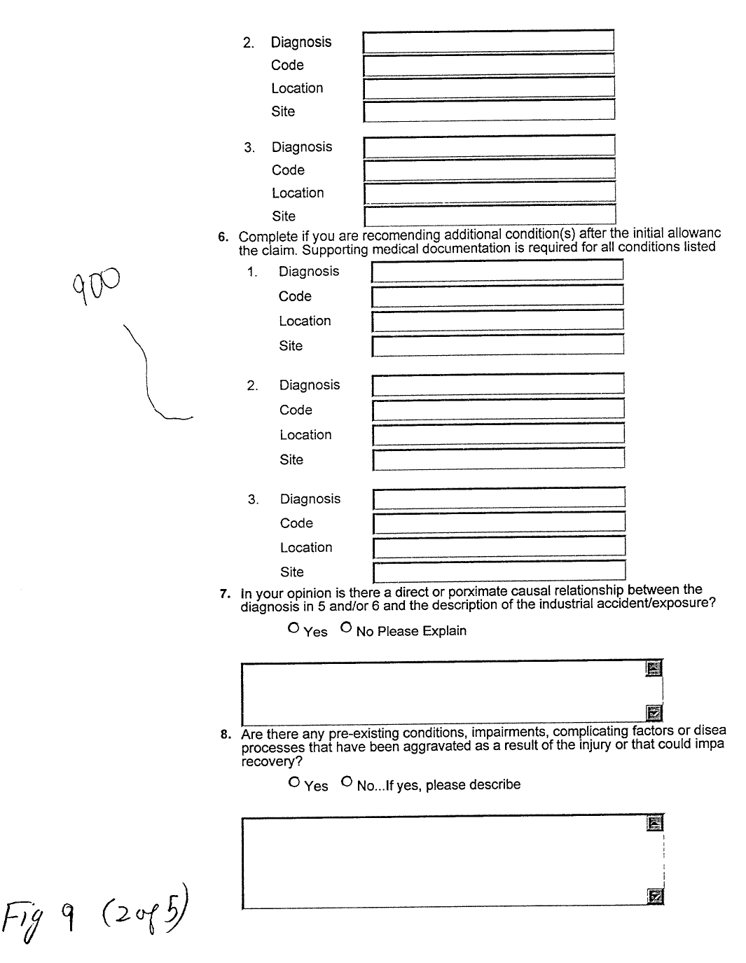

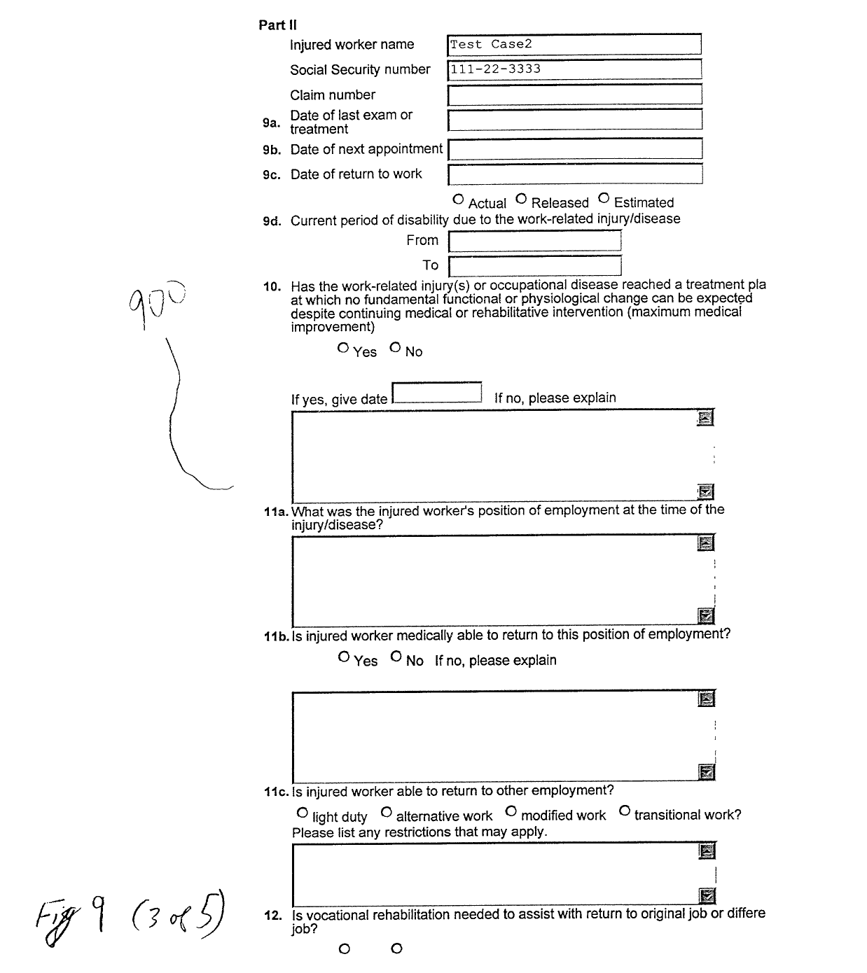

With reference now to FIG. 4, the treatment plan as implemented in the preferred embodiment is described in greater detail. The treatment plan is preferably divided into treatment intervals, e.g. into two-week treatment plan intervals 60₁, 60₂, 60₃, . . . 60_{N}, to permit close tracking of the rehabilitation process. Each treatment interval 60 includes a plurality of components such as physical therapy 62, diagnostic testing 64, pain management 66, and return to work 68. An important feature of the invention is that the treatment plan is updated, e.g. on a bi-weekly basis, according to the anticipated and the actual (measured) recovery of the injured worker. Thus, physical therapy plans 62₁, 62₂, 62₃, . . . 62_{N}, are distinct physical therapy plans. Similarly, diagnostic testing plans 64₁, 64₂, 64₃, . . . 64_{H}, are distinct plans; pain management plans 66₁, 66₂, 66₃, . . . 66_{N}, are distinct plans; and return to work plans 68₁, 68₂, 68₃, . . . 68_{N}, are distinct plans. Some typical treatment plan interval contents are shown in FIGS. 7 and 8, which depict an exemplary treatment plan including a physical therapy plan 200, a diagnostic testing plan 400, a pain management plan 600, and a return to work plan 800. It will be observed in particular that the return to work plan 800 is not a binary decision response, but rather specifies the allowable work tasks, and bounds on the allowed work tasks. This detailed information optionally enables the injured worker to return to work in a limited capacity, for example in a bridge assignment.

An important aspect of the treatment plan is that it is interactive with ongoing testing of the injured person. Such assessments provide information on the current status of the rehabilitation and are advantageously used to update future treatment plan intervals. With continuing reference to FIG. 4, a plurality of testing centers, e.g. testing centers 70, 72 are typically utilized. These testing centers are optionally operated by the same entity which provides the case management system. In order to access a wide range of rehabilitation assessment diagnostics, however, the method optionally advantageously engages outside testing centers, for example on a contractual basis.

In the preferred embodiment, the method automates scheduling of assessment testing. For example, FIG. 7 shows a selection option in the Diagnostic section 400 to “Schedule an X-ray” 402. Selection of this option by the user will bring up an appropriate scheduling form (not shown) by which the injured person is scheduled for the test. As shown in FIG. 4, the scheduling information is forwarded to the testing center 82, 84. Preferably, the method enables for pre-certification of the scheduled test when said test is scheduled through the case management system in accordance with the treatment plan interval 60, such as by selecting the option 402 shown in FIG. 7 and filling out the subsequently presented scheduling form (not shown). Such pre-certification reduces paperwork and minimizes delays in performing the testing versus prior art methods that typically require manual approval of tests on a case-bycase basis.

It will be appreciated that the scheduling of tests is not identical for the treatment plan intervals 60, but rather different tests are scheduled within each treatment plan interval 60₁, 60₂, 60₃, 60_{N}. The first treatment plan interval 601 schedules 82 a test at a first testing center 70. This testing center 70 can, for example, be a medical imaging center that performs an X-ray of the injured body part. Later, during the third treatment plan interval 60₃ another test is scheduled 84 at a second testing center 72. The testing center 72 can, for example, be a physical performance test center performing, for example, a strength test of the partially rehabilitated body part that in the exemplary case is appropriate as the therapy progresses around the 5th-6th week of rehabilitation. The treatment plan intervals 62₂ and 62_{N} do not show any scheduled tests.

Assessment tests advantageously provide feedback data 86, 88 to the treatment plan. For example, the results of the medical imaging test scheduled by the first treatment plan interval 60₁ are optionally used to modify the second treatment plan interval 60₂. Such modification is preferably performed by the processor 8 based upon comparisons of the test results with information contained in the treatment database 4B.

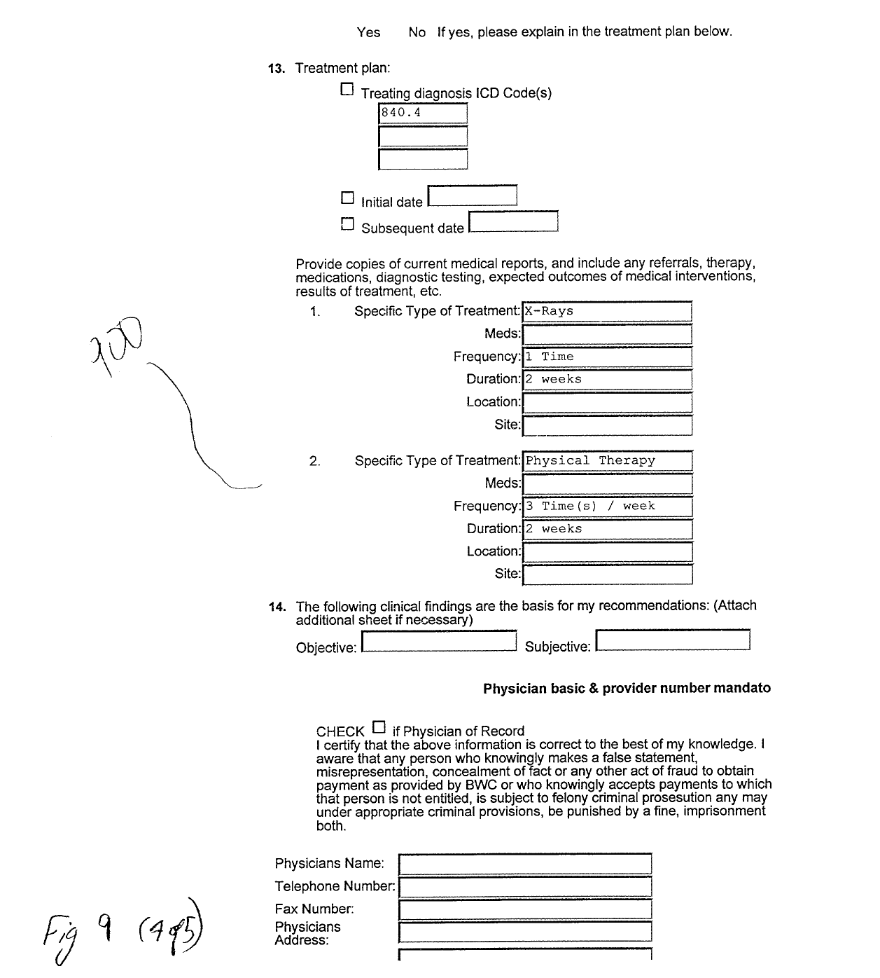

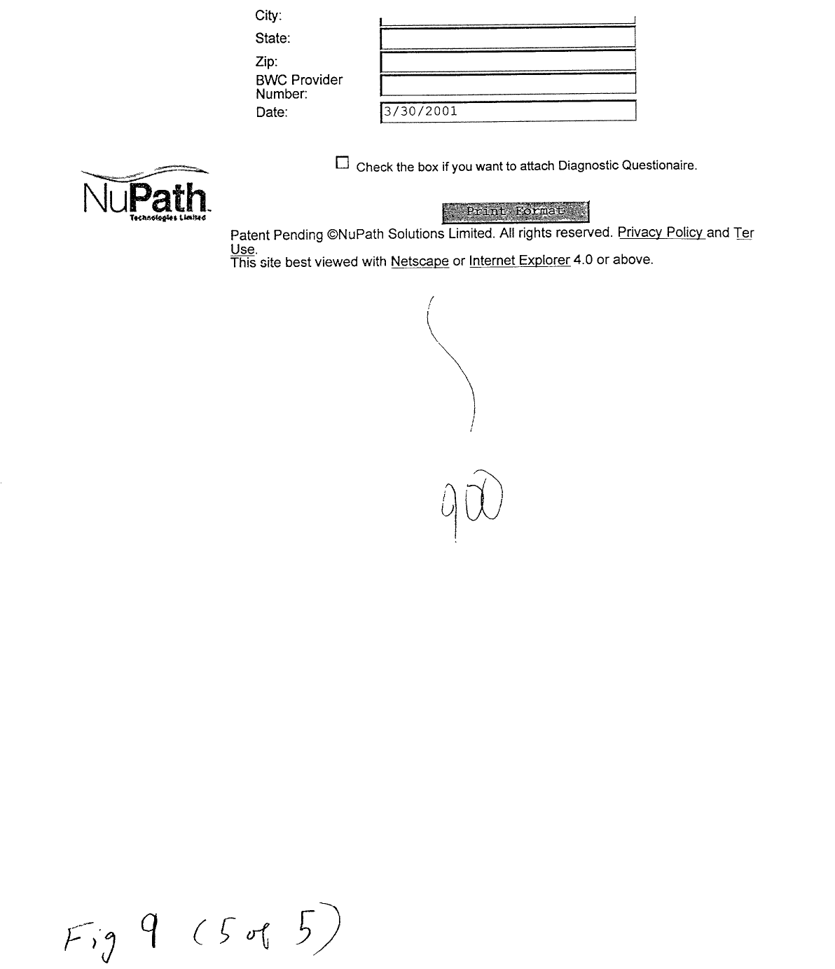

With continuing reference to FIG. 4, a report generator 90 is preferably provides completed forms and other paperwork for regulatory agencies, medical personnel, and others. For example, the diagnostic questionnaire is optionally printed in a readable format 92. Similarly, the C-b 9 Physician's Report/Treatment Plan is optionally printed 94. FIG. 9 shows a typical C-9 Physician's Report/Treatment Plan 900. Preferably, the report generator 90 also produces reports that are compliant with particular relevant regulatory agencies or organizations. In the exemplary FIG. 4, URAC compliant reports are optionally generated concerning the patient 96. Similarly, URAC compliance reports are preferably generated corresponding to the scope management scope of a supervisor 98A, a case manager 98B, or the entire MCO 98C. These URAC reports are expected to be required in Ohio in the near future. Of course, other report types are also optionally produced by the report generator 90.

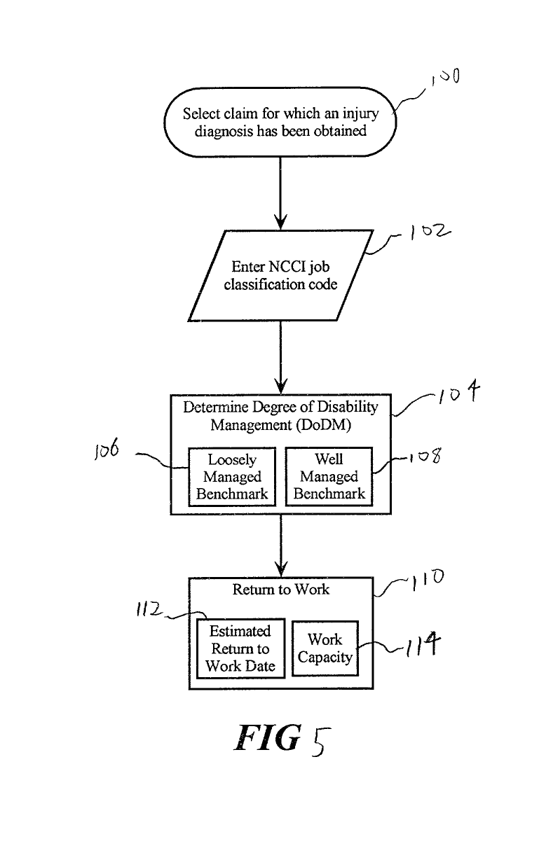

With reference now to FIG. 5, a preferred method for estimating a return to work date is described. A claim for which an injury diagnosis has already been established is selected in a step 100. The user is prompted to enter a job classification code for the injured person in a step 102. Preferably, the NCCI job classification code is used, but of course other job classification schemes may be used instead. Optionally, the input NCCI job classification code is verified for validity against the job classification codes database 4D. Other interfaces therefor are also contemplated. For example, a drop-down selection list can be used to select the job classification, with the corresponding NCCI code being extracted from the job code database 4D based on the list selection. This latter embodiment advantageously eliminates the need for the user to be familiar with the complex NCCI job classification scheme.

Based upon the job classification code and the treatment diagnosis, a degree of disability management (DoDM) code is determined in a step 104. In determining a DoDM, preferably at least two associated benchmarks are obtained: a loosely managed benchmark 106, and a well managed benchmark 108, which give estimated upper and lower bounds, respectively, on the number of days of work which are expected to be missed due to the injury. Preferably, the well managed benchmark 108 corresponds to the anticipated time period before the person returns to work when managed using the case management system embodiment in accordance with the invention, whereas the loosely managed benchmark is a statistical figure that indicates a rehabilitation period typically observed in practice.

Based on the DoDM and the associated benchmarks 106, 108 as well as the first report of injury (FROI) date, an estimated return to work date is set in a step 110. The estimated return to work date 112 is preferably calculated as the date of the well managed benchmark 108 relative to the FROI, e.g. if the FROI is January 1 and the well managed benchmark 108 is twenty days, then the estimated return to work date 112 is January 21. However, the method optionally incorporates other factors, such as the person's age and health, scheduled holidays, et cetera.

Preferably, an estimated work capacity 114 is also determined at this time, which provides information on limitations which are preferably placed on the rehabilitated person's job duties (e.g., limits on the amount of lifting allowed, or on repetitive tasks, etc). The work capacity 114 is preferably determined using information contained in the treatment database 4B.

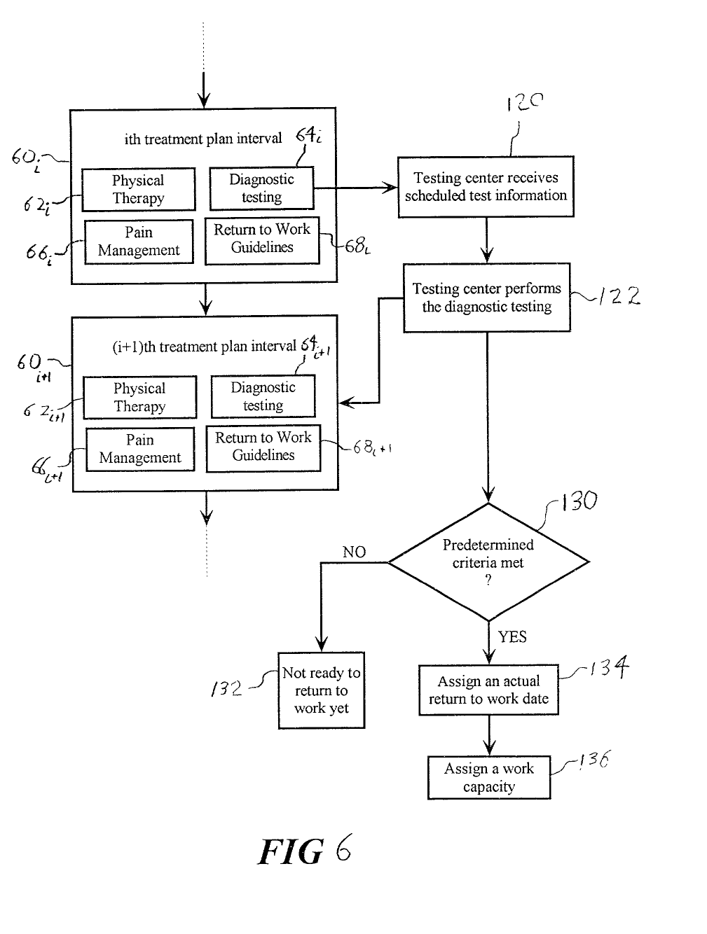

With reference now to FIG. 6 and with continuing reference to FIG. 4, the use of diagnostic testing as a means for qualifying the worker for an actual return to work is described. In a step 120, a testing center receives the scheduled test information from the diagnostic testing component 64ᵢ of a treatment plan interval 60ᵢ. The diagnostic testing is then performed at the testing center 122, and the results are preferably sent back to modify subsequent treatment plan intervals, e.g. interval 60ᵢ₊₁.

Diagnostic testing data is preferably used for making decisions about an actual return to work date. It will be recalled that the estimated return to work date 112 is calculated in a step 110 of FIG. 5. That date is only an estimate which is preferably refined at each treatment plan interval 60ᵢ based upon feedback such as diagnostic test results. However, in view of the potential negative consequences of a premature return to work (e.g., re-injury of the body part and the consequent additional missed work and required medical treatment) qualification for an actual return to work is preferably based on satisfying predetermined diagnostic testing criteria. As shown in FIG. 6, the diagnostic test data are compared with a predetermined criteria in a decision step 130. The predetermined criteria are preferably job-specific and reflect the physical capabilities required for safe and satisfactory job performance, as indicated by the diagnostic testing results. The criteria are preferably stored in the treatment database 4B. A decision is made based on the comparison with the predetermined criteria in the step 130. If the criteria are not met, then the injured person is judged not ready to return to work in a step 132, and the treatment plan will continue according to treatment plan intervals 60ᵢ, 60ᵢ₊₁.

If the criteria are met, however, then an actual return to work date is set in a step 134. The actual return to work date is set to any time subsequent to the decision 130, but is preferably set as soon as possible after that decision date to minimize the number of lost work days. Preferably, a work capacity is assessed and assigned essentially simultaneously with the actual return to work date in a step 136. The work capacity preferably includes limitations on lifting, repetitive tasks, or other physical activities which are judged based upon the diagnostic testing and other factors to be likely to aggravate the injury. The treatment plan optionally continues after the return to work, albeit with possible modifications of the current and subsequent treatment plan intervals 60ᵢ₊₁, et cetera, until full rehabilitation is achieved.

The treatment management method has been described with particular reference to FIGS. 2-8. The managed care system typically includes, in addition to treatment management, means for recording and maintaining medical history information, work status information, physician of record information, a permanent record of the diagnostic and treatment actions taken, et cetera. The managed care system also preferably includes a means for registering and tracking patient complaints, medical referrals, and the like. This information is preferably stored on the data store 4 and accessible via the Internet 2 through the processor 8. In a preferred embodiment, the information recorded and tracked by the care management system and method includes information suggested or required by the American Accreditation HealthCare Commission, also known as URAC. The URAC standards are presently being adopted by the Ohio Bureau of Workers' Compensation (BWC), and compliance therewith is expected to be required of all MCO's operating in Ohio. Support for URAC reporting requirements is also preferable because a number of other states are considering adopting the URAC reporting standards or portions thereof.

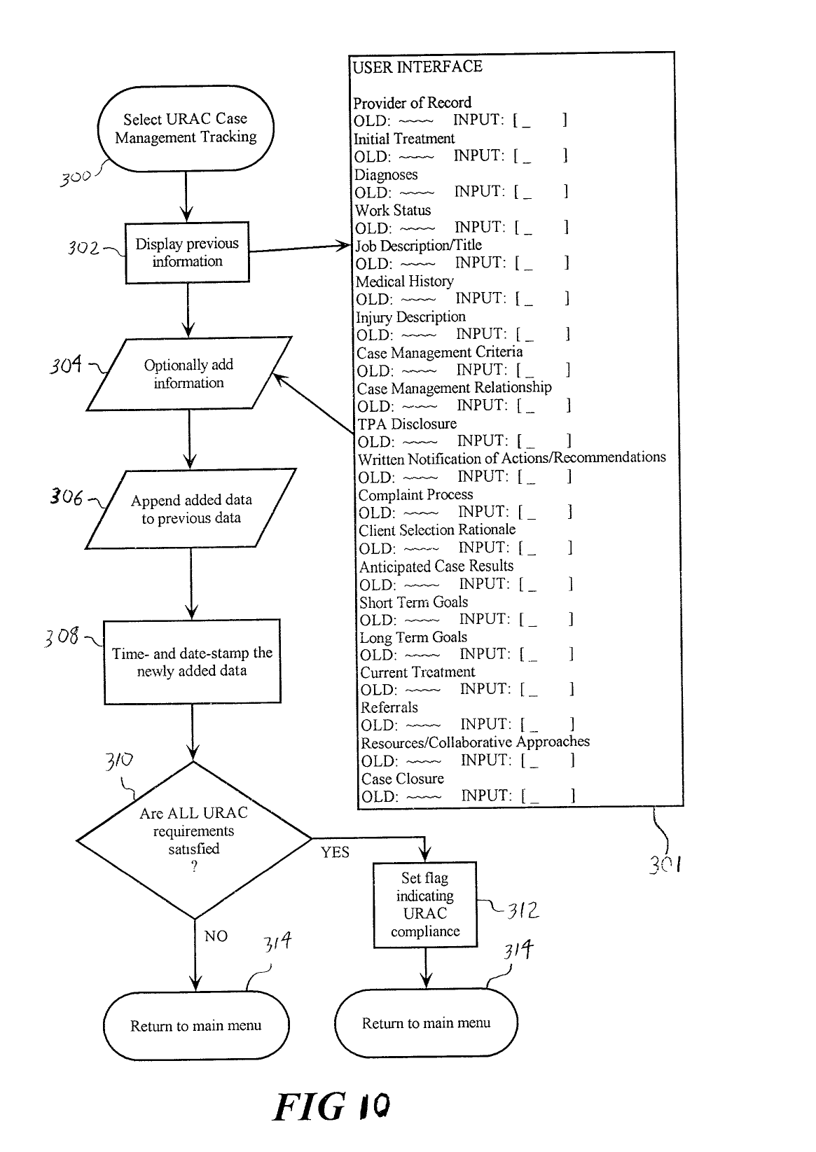

With reference now to FIG. 10, a preferred interfacing with the regulatory record-keeping aspect of the invention in accordance with the URAC standards is described. The user selects the case management tracking option, which is preferably a URAC compliant tracking system, in a step 300. The previously entered information for each injured person is displayed 301 in a step 302. The displayed information is preferably divided into URAC-defined categories that in the exemplary embodiment of FIG. 10 include: “Provider of Record”, “Initial Treatment Information”, “Diagnoses”, “Work Status”, “Job Description/Title”, “Medical History”, “Injury Description”, “Case Management Criteria”, Case Management Relationship”, “TPA Disclosure”, “Written Notification of Actions/Recommendations”, “Complaint Process”, “Client Selection Rationale”, “Anticipated Case Results”, “Short Term Goals”, “Long Term Goals”, “Current Treatment Information”, “Referrals”, “Resources/Collaborative Approaches”, and “Case Closure”. Of course, more, fewer, or different categories can be included in the case management tracking system.

Preferably, the information displayed in the step 302 is read-only information. That is, preferably, the user is prevented from modifying previously entered information. This ensures the integrity of the data and facilitates meeting URAC and other typical regulatory requirements for secure maintenance of case management records. The user is preferably limited to appending additional information in a step 304. Thus, for example, a change in the “Provider of Record” corresponding to a change in the treating physician is preferably recorded by adding an entry indicating the change. The added information is saved in a step 306 at which step the newly added entries are preferably appended to the previously entered information without any overwriting. Each entry is optionally automatically date- and time-stamped as it is saved in a step 308.

The system advantageously tracks whether or not full URAC compliance is achieved for each injury case. Thus, after saving the updated information, a check for full URAC compliance is made in a decision step 310. This decision can be based, for example, on whether any URAC categories remain uncompleted. For example, a blank “Provider of Record” category can prevent the injury case for being fully URAC compliant. If full URAC compliance is achieved for the instant case, the system marks the injury case as URAC compliant in a step 312. Regardless of the decision made in step 310, the user exits the case management tracking system in a step 314.

The URAC case tracking information recorded using the case management tracking method of FIG. 10 is preferably used by the report generator 90 to display the URAC reports 96, 98A, 98B, 98C indicated in FIG. 4.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

Having thus described the preferred embodiments, the invention is now claimed to be:

1. A case management method for managing a worker injury claim, comprising:
maintaining a database of suggested treatment plans;
recording a first report of injury (FROI) date;
identifying an injured body part;
obtaining an injury diagnosis;
assigning an injury classification code based on the obtained diagnosis and the identified injured body part;
receiving an associated job code;
identifying a degree of disability management (DoDM) code based on the injury classification code and the associated job code; and
providing a treatment plan based on the diagnosis, said treatment plan being extracted from the database of treatment plans.

2. The case management method according to claim 1, wherein the step of assigning an injury classification code includes assigning an ICD-9 code.

3. The case management method according to claim 1, wherein the step of receiving an associated job code includes receiving an associated NCCI job code.

4. The case management method according to claim 1, wherein the step of identifying a DoDM code includes:
identifying a loosely managed benchmark code; and
identifying a well managed benchmark code.

5. The case management method according to claim 4, wherein the step of identifying a loosely managed benchmark code includes:
identifying a statistical average period between injury and return to work corresponding to the injury classification code and the associated job code.

6. The case management method according to claim 4, wherein the step of identifying a well managed benchmark code includes:
estimating a period between injury and return to work corresponding to the injury classification code and the associated job code based on the provided treatment plan.

7. The case management method according to claim 4, further comprising:
estimating an estimated return-to-work date based upon the first report of injury (FROI) date and the well managed benchmark.

8. The case management method according to claim 7, wherein the step of estimating an estimated return-to-work date includes adding the well-managed benchmark to the FROI date.

9. The case management method according to claim 1, wherein the step of obtaining a diagnosis includes:
receiving responses to a diagnostic questionnaire; and
supplying a suggested diagnosis by comparing the responses with a preexisting diagnosis database.

10. The case management method according to claim 1, further comprising:
dividing the treatment plan into treatment intervals wherein each said interval is assigned to a time block subsequent to the first report of injury (FROI).

11. The case management method according to claim 10, further comprising:
receiving updated information on the injured worker, said updated information having become available after the first report of injury (FROI) and after the obtaining of the injury diagnosis;
updating a treatment interval based upon the updated information; and
updating the estimated return-to-work date based upon the updated information.

12. The case management method according to claim 11, wherein the step of receiving updated information includes receiving information from a diagnostic testing of the injured worker.

13. The case management method according to claim 12, further comprising scheduling the diagnostic testing in accordance with the treatment plan.

14. The case management method according to claim 12, further including pre-certifying the diagnostic testing conditional upon the diagnostic testing being included in the treatment plan.

15. The method according to claim 1, further comprising:
displaying initial case management tracking information;
receiving from the user additional case management tracking information; and
appending the received additional case management tracking information to the initial case management tracking information without modifying the initial case management tracking information.

16. The method according to claim 15, wherein the step of displaying case management tracking information includes displaying URAC-compliance case management tracking information.

17. The method according to claim 16, further comprising:
setting a URAC compliance flag conditional upon meeting a preselected set of conditions indicating compliance with URAC standards.

18. A case management system for managing rehabilitation of an injured worker, the case management system comprising:
a central data store comprising at least one data storage unit;
an injury classification code database maintained on the central data store;
a treatment database maintained on the central data store; and
a processor in operative communication with the central data store and in operative communication with the Internet, said processor performing the steps of:
creating a claim file on the central data store,
receiving information about the claim via the Internet,
storing the received information in the claim file,
establishing a diagnosis corresponding to the claim,
creating a treatment plan based on the diagnosis using information extracted from the treatment database, and
selectably transmitting selected information extracted from the claim file via the Internet conditional upon receipt of valid security information.

19. The case management system as set forth in claim 18, further including:
a diagnosis database that is maintained on the central data store; and
an Internet diagnosis questionnaire that is accessible via the Internet.

20. The case management system as set forth in claim 19 wherein step of establishing a diagnosis includes the steps of:
receiving responses to the Internet-based diagnosis questionnaire via the Internet; and
providing a suggested diagnosis by comparing the received responses with information contained in the diagnosis database.

21. The case management system as set forth in claim 18 wherein the step of creating a treatment plan includes the step of:
dividing the treatment plan into treatment intervals corresponding to pre-selected time intervals.

22. The case management system as set forth in claim 18, wherein the processor performs the additional steps of:
pre-certifying a diagnostic test in accordance with the created treatment plan;
receiving results of the diagnostic test; and
updating the treatment plan based on the received results and the treatment database .

23. The case management method according to claim 18, wherein the processor further performs the steps of:
identifying a loosely managed benchmark code; and
identifying a well managed benchmark code.

24. The case management method according to claim 23, wherein:
the step of identifying a loosely managed benchmark code includes identifying a statistical average period between injury and return to work corresponding to the injury classification code and the associated job code.

25. The case management method according to claim 23, wherein the step of identifying a well managed benchmark code includes:
estimating a period between injury and return to work corresponding to the injury classification code and the associated job code based on the provided treatment plan.

26. The case management method according to claim 23, further comprising:
estimating an estimated return-to-work date based upon the first report of injury (FROI) date and the well managed benchmark.

27. The case management method according to claim 26, wherein the step of estimating an estimated return-to-work date includes adding the well-managed benchmark to the FROI date.
